(19) United States
(12) Patent Application Publication
(10) Pub. No.: US 2005/0078710 A1
(43) Pub. Date: Apr. 14, 2005

(54) GENERAL INTERFACE CONTROL CIRCUIT

(76) Inventor: Hui-Huang Chang, Hsin-Chu Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/710,889

(22) Filed: Aug. 11, 2004

(30) Foreign Application Priority Data
Oct. 8, 2003 (TW) 092128001

(51) Int. Cl. H04J 1/16

(52) U.S. Cl. 370/503

(57) ABSTRACT

An general interface control circuit for outputting or inputting a predetermined number of data includes at least a control table for providing a predetermined sequence, a predetermined number of I/O pins, and predetermined cycles for outputting/inputting the predetermined number of data. The interface control circuit further includes a timing control unit electrically connected to the control table for outputting/inputting the predetermined number of data through the predetermined number of I/O pins during the predetermined cycles.

### BACKGROUND OF INVENTION

1. Field of the Invention

The invention relates to an interface control circuit and method thereof, and more particularly, to an interface control circuit and method for adjusting a sequence of the transmitted data, numbers and positions of I/O pins, and an output/input timing and control signal.

2. Description of the Prior Art

Generally, two circuit systems can be coupled to each other through an interface control circuit along with predefined transmitting data types, a predetermined number of I/O pins, and a predetermined number of clock cycles during which the data transmission has to be finished. FIG. 1 is a functional block diagram of a typical interface control circuit 12. The interface control circuit 12 is installed in a first circuit system 10, and the first circuit system 10 can communicate with a second circuit system 14 via the interface control circuit 12. The first circuit system 10 further includes a plurality of first pins 18 which are used to output or input data. The second circuit system 14 is installed with a plurality of corresponding second pins 20 and a second internal circuit 22. When being connected, regarding the communication between the first circuit system 10 and the second circuit system 14, the second circuit system 14 may conform to different specifications. The second circuit system 14 under each specification will correspond to a specific output/input timing and pin count (the number of the second pins 20) so that the interface control circuit 12 of the first circuit system 10 has to make a specific arrangement when the first circuit system 10 is coupled to the second circuit system 14 under such specification. In addition, when the first circuit system 10 is simultaneously coupled to a plurality of second circuit systems 14 of various specifications, the operations of the interface control circuit 12 will be much more complicated. For instance, the first circuit system 10 as shown in FIG. 1 can be treated as a printer control digital circuit and coupled to a plurality of print heads of different standards so as to control operations of the print heads. If the print heads are respectively installed with various power driving chips of different specifications (corresponding to the second circuit systems 14) and those power driving chips of different specifications correspond to different control interfaces, it is not easy for the first circuit system 10 to conform to the various specifications if the first circuit system 10 is implemented with only one interface.

Conventionally, a microprocessor can be utilized to implement the interface control circuit 12 shown in FIG. 1 with related firmware involved to process data. The data can be transmitted to the second circuit system 14 in a predetermined sequence via the first pins 18 and the second pins 20. Even though the firmware can be modified to meet various requirements of the different second circuit systems 14 and the interface setting can be adjusted to achieve transmitting operations, the setting of the interface control circuit 12 is still unchanged after the firmware is determined. Alternatively, a programmable gate array can be utilized to adjust the transmitting timing of the control interface. The programmable gate array can be used to meet various requirements of different second circuit systems 14 by modifying related circuit parameters of the interface control circuit 12 shown in FIG. 1 so that the programmable gate array can achieve higher flexibility. However, the programmable gate array is more complicated and occupies more circuit area in a chip, thereby raising the cost.

### SUMMARY OF INVENTION

It is therefore one of the many objectives of the claimed invention to provide an interface control circuit and method for adjusting characteristics of the interface control circuit to raise the flexibility of the interface control circuit.

In the claimed invention, a plurality of updateable control tables are installed in an interface control circuit to meet the requirements of the externally coupled circuits of various specifications by adjusting transmission characteristics of the interface control circuit. By searching the control tables, the data being outputted can be read and arranged in a predetermined sequence while a predetermined number of pins are selected. The data arranged in the predetermined sequence can be recorded into corresponding pins of the predetermined number of pins. At last, the data can be outputted according to an output/input timing. The three updateable control tables of the present invention, a data select sequence table, a pin select sequence table, and an output/input timing control table, can be used to respectively determine the predetermined sequence of the outputted data, the output/input pin count, and the output/input timing. Therefore, the interface control circuit of the present invention can be used to output or input the predetermined number of data in a predetermined sequence via a predetermined number of pins within a predetermined number of cycles.

These and other objectives of the present invention will no doubt become obvious to those of ordinary skill in the art after reading the following detailed description of the embodiments, which is illustrated in the various figures and drawings.

### BRIEF DESCRIPTION OF DRAWINGS

FIG. 1 is a functional block diagram of a typical interface control circuit.

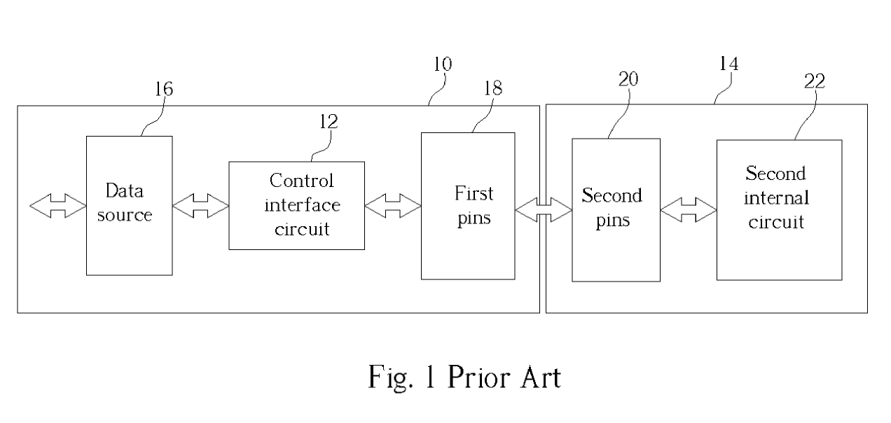

FIG. 2 is a schematic diagram of an embodiment interface control circuit according to the present invention.

FIG. 3 is a detailed schematic diagram of a general interface control circuit according to an embodiment of the present invention.

FIG. 4 is a schematic diagram showing the operating conditions of the data select sequence module and the pin select sequence module when the data is outputted from the circuit system.

FIG. 5 is a schematic diagram showing the structure and operations of the output/input timing control module.

FIG. 6 is a schematic diagram showing operating conditions of the data select sequence module and the pin select sequence module when the data are inputted.

FIG. 7 is a schematic diagram of the general interface control circuit according to another embodiment of the present invention.

### DETAILED DESCRIPTION

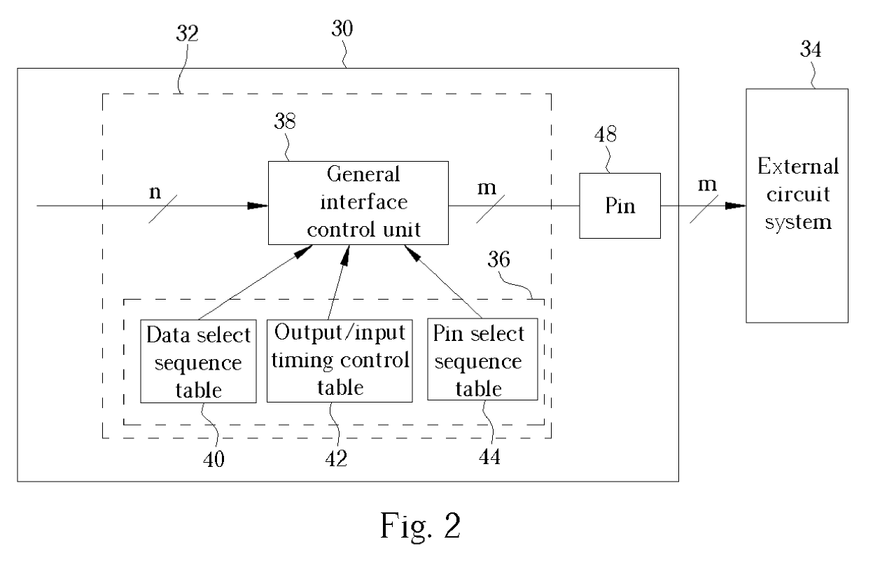

FIG. 2 is a schematic diagram of an embodiment interface control circuit 32 according to the present invention. The interface control circuit 32 is installed in a circuit system 30, and the circuit system 30 can communicate with an external circuit system 34 via the interface control circuit 32. In order to meet the interface control requirement of the external circuit system 34, in the circuit system 30, a predetermined number (n) of data should be outputted to the external circuit system 34 via a predetermined number (m) of pins 48 within a predetermined number (T) of cycles. The interface control circuit 32 includes at least a control table 36 and a general interface control unit 38. The control table 36 can be used for providing parameters including a predetermined sequence, a predetermined number of pin count, and a predetermined number of cycles. The general interface control unit 38 is coupled to the control table 36 and used to output the n sets of data from the predetermined m pins 48 to the externally coupled external circuit system 34 during the predetermined T cycles according to the parameters provided by the control table 36. For instance, according to the requirement of the external circuit system 34, when n is set as 50 while m is set as 10, T should be larger than or equal to 5 (50/10=5). Therefore, the interface control circuit 32 is configured to output the 50 sets of data via the predetermined 10 pins 48 in turn during at least 5 cycles.

The control tables 36, in this embodiment, include a data select sequence table 40, a pin select sequence table 44, and an output/input timing control table 42. The data select sequence table 40 is used to provide the above-mentioned predetermined sequence. The pin select sequence table 44 provides in advance the predetermined pin count, while the output/input timing control table 42 provides the above-mentioned predetermined number of cycles. Since the contents of the control table 36 are updateable, designers or users can adjust the parameters in the control table 36 to meet various requirements of different control interfaces (of different external circuit systems 34). In a practical embodiment, the data select sequence table 40, the pin select sequence table 44, and the output/input timing control table 42 can be respectively stored in a memory device. The memory device can be a RAM, ROM, and so on.

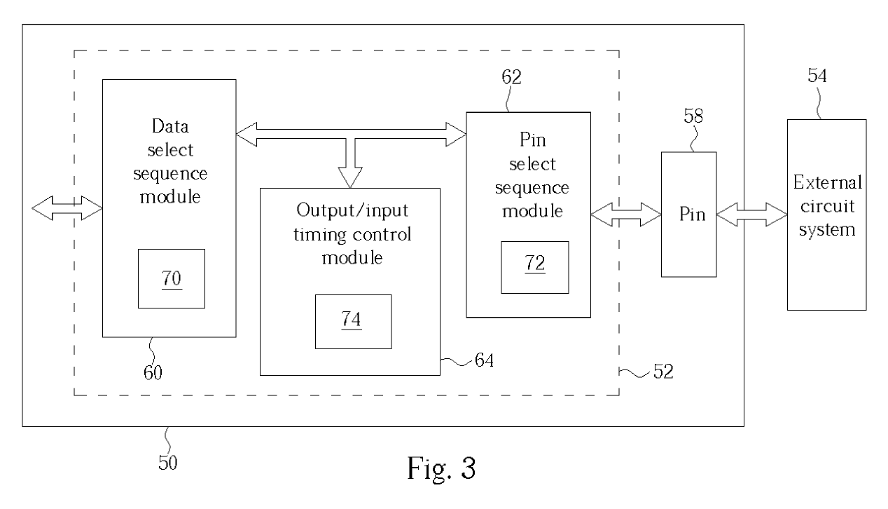

Please refer to FIG. 3, which is a detailed schematic diagram of an interface control circuit 52 according to another embodiment of the present invention. The interface control circuit 52 includes a data select sequence module 60, a pin select sequence module 62, and an output/input timing control module 64. The data select sequence module 60 includes a data select sequence table 70 for providing a predetermined sequence. The data select sequence module 60 can be used to access a predetermined number of data from the circuit system 50 according to the predetermined sequence. The pin select sequence module 62 includes a pin select sequence table 72 for determining the predetermined pin count and the pins 58 respectively corresponding to the output/input data. The pin select sequence module 62 can be used to record the data into the predetermined number of pins 58 according to the content of the pin select sequence table 72. The output/input timing control module 64, which is coupled between the data select sequence module 60 and the pin select sequence module 64, includes an output/input timing control table 74 for providing an output/input timing and at least a control signal so that operations of the data select sequence module 60 and of the pin select sequence module 64 can be organized by the output/input timing control module 64. Therefore, the predetermined number of data can be outputted from the circuit system 50 or inputted to the circuit system 50 from the external circuit system 54 via the predetermined number of pins 58 during the predetermined number of cycles.

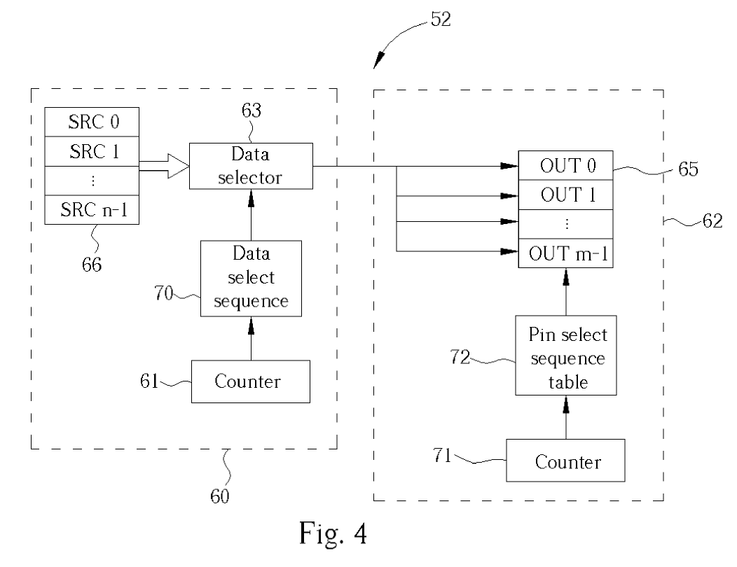

FIG. 4 shows the operating conditions of the data select sequence module 60 and the pin select sequence module 62 when the data is outputted from the circuit system 50. The data select sequence module 60 includes a data select sequence table 70, a predetermined number of data selectors 63, and a counter 61. The counter 61 can be used to address the data select sequence table 70 so that the data selector 63 (can be a multiplexer) can be used to pick a predetermined number (n) of data (SRC0, SRC1, . . . , SRCn−1) sequentially from a data source 66 of the circuit system 50 that is stored with a plurality of data according to the predetermined sequence provided in the data select sequence table 70. The picked predetermined number (n) of data will be transmitted to the pin select sequence module 62 according to the predetermined sequence. The pin select sequence module 62 includes a pin select sequence table 72, and a counter 71 coupled to the pin select sequence table 72, and an output register 65 (OUT0, OUT1, . . . , OUTm−1) corresponding to the predetermined number (m) of pins 58. The pin select sequence table 72 can determine in advance the predetermined pin count (m) while the counter 71 can address the pin select sequence table 72 so that the pin select sequence table 72 can be used to determine appropriate output pins 58 to record the predetermined number (n) of data into the output register 65 that is equipped with m storage units. In another embodiment, the data selector 63 can be neglected while the data select sequence table 70 can be used directly to drive the data source 66 to output the data to the output register 65.

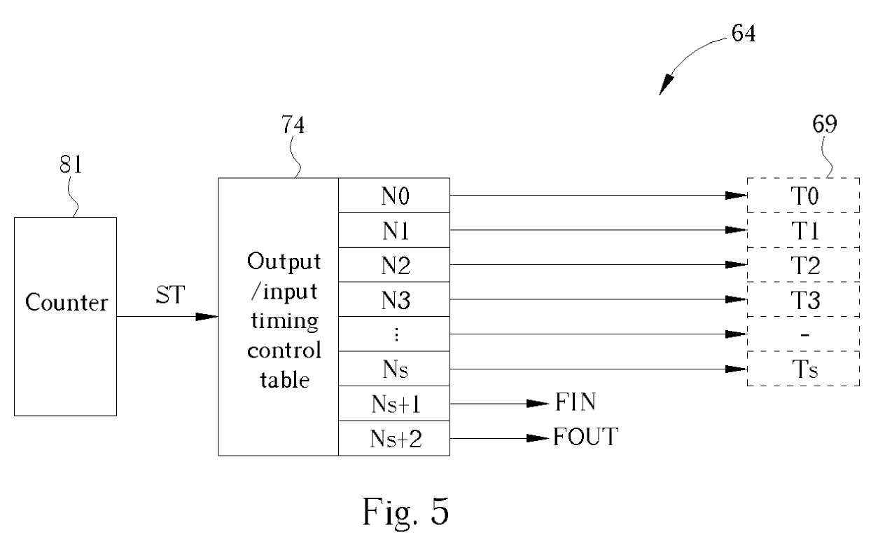

FIG. 5 shows the structure and operations of the output/input timing control module 64. Refer to both FIG. 5 and FIG. 4, the output/input timing control module 64, which is coupled to the data select sequence module 60 and the pin select sequence module 62, includes a counter 81 and an output/input timing control table 74. In the output/input timing control module 64, the counter 81 can be used to transmit a sequencing signal ST to the output/input timing control table 74. Since the output/input timing control table 74 contains the output/input timing and related control signals (N0, N1, . . . , Ns, . . . , Ns+2) for interface control, the data select sequence module 60 and the pin select sequence module 62 can cooperate according to the content of the output/input timing control table 74. In the meantime, those signals can be directly outputted from the output/input timing control module 64 through a register or a latch 69 (T0 to Ts) to achieve synchronous transmission. Moreover, the control signals, including an input control signal FIN and an output control signal FOUT shown in FIG. 5, can also include information related to the input/output operation; that is, the data select sequence module 60 and the pin select sequence module 62 can perform data outputting/inputting functions according to those control signals.

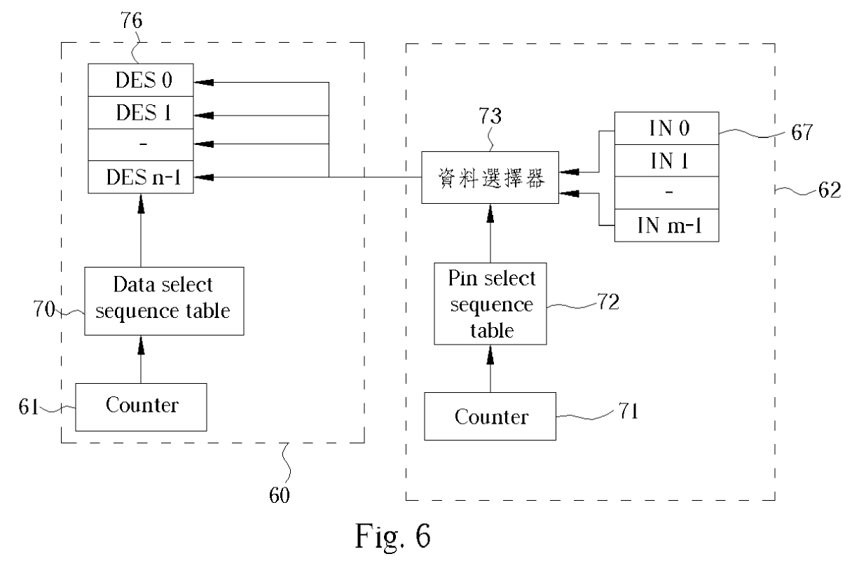

Please refer to FIG. 6, which shows operating conditions of the data select sequence module 60 and the pin select sequence module 62 when the data are inputted. The pin select sequence module 62 includes the pin select sequence table 72, the counter 71, an input register 67, and a data selector 73. The input register 67 (IN0, IN1, INm−1) is similar to the output register 65 shown in FIG. 4 and corresponds to the m pins 58 of the circuit system 50. The counter 71 is coupled to the pin select sequence table 72 to address the pin select sequence table 72 to provide the predetermined pin count and the sequence in which the data are inputted from the input register 67. The data selector 73 (may be a multiplexer) can be used to pick the valid input data, which will then be transmitted to a predetermined number of data objective positions 76 (DES0, DES1, . . . , DESn−1) and the data select sequence module 60 in the circuit system 50 according to the content of the pin select sequence table 72. The data select sequence module 60 includes the data select sequence table 70 and the counter 61 for providing the predetermined sequence. The counter 61 addresses the data select sequence table 70 so that the data select sequence table 70 can be used to record the predetermined number of data chosen by the data selector 73 to the data objective positions 76 according to the predetermined sequence. In another embodiment, the data selector 73 can be neglected while the pin select sequence table 72 can be used directly to drive the input registers 67 to input the data to the data objective positions 76.

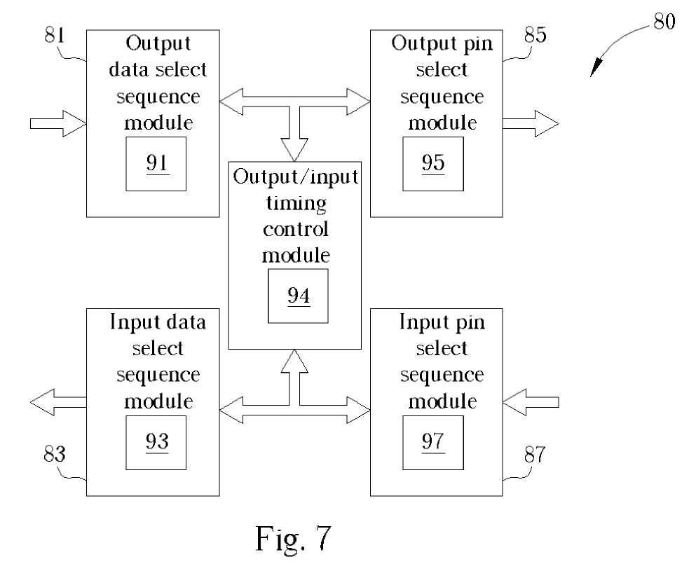

When differentiating the data outputting procedure from the data inputting procedure, the data select sequence module 60 can be separated into an output data select sequence module 81 and an input data select sequence module 83 while the pin select sequence module 62 can be separated into an output pin select sequence module 85 and an input pin select sequence module 87, respectively embedded with sequence tables 91, 93, 95, and 97. The above-mentioned structure can refer to the embodiment shown in FIG. 7, which is a schematic diagram of another embodiment of the interface control circuit 80 according to an embodiment of the present invention.

Actually, each of the three control tables, including the data select sequence table, the pin select sequence table, and the output/input timing control table, can be treated as an independent characteristic and respectively applied in interface control circuits. Accordingly, by searching tables to arrange the output/input interface, the interface control circuit can adjust the sequence of the outputted data, the output/input pin count, and the output/input timing to meet the requirements of various interface circuits.

Those skilled in the art will readily observe that numerous modifications and alterations of the device may be made while retaining the teachings of the invention. Accordingly, that above disclosure should be construed as limited only by the metes and bounds of the appended claims.

1. An interface control circuit used in a circuit system for transmitting data, the interface control circuit comprising:
a plurality of I/O pins;
an I/O-pin select sequence table for recording at least an I/O-pin data set; and
an I/O-pin sequence select module for transmitting the data sequentially through the plurality of I/O pins according to the I/O-pin data set.

2. The interface control circuit of claim 1 wherein the circuit system is coupled to a second circuit system, and content of the I/O-pin select sequence table conforms to requirements of the second circuit system.

3. The interface control circuit of claim 1 further comprising:
a data select sequence table for providing a predetermined sequence; and
a data sequence select module for sequentially transmitting the data according to the predetermined sequence through at least one of the I/O pins.

4. The interface control circuit of claim 1 further comprising:
a timing control table for providing a cycle data set; and
a timing control unit for transmitting the data according to the cycle data set.

5. The interface control circuit of claim 4 wherein the timing control unit outputs a timing signal according to the cycle data set.

6. An interface control circuit for transmitting data, the interface control circuit comprising:
at least an I/O pin;
a data select sequence table for providing a predetermined sequence; and
a data sequence select module for sequentially transmitting the data according to the predetermined sequence through the I/O pin.

7. The interface control circuit of claim 6 wherein the circuit system is coupled to a second circuit system, and content of the data select sequence table conforms to requirements of the second circuit system.

8. The interface control circuit of claim 6 further comprising:
a timing control table for providing a cycle data set; and
a timing control unit for transmitting the data according to the cycle data set.

9. The interface control circuit of claim 8 wherein the timing control unit outputs a timing signal according to the cycle data set.

10. An interface control circuit for outputting a timing signal, the interface control circuit comprising:
a timing control table for providing a cycle data set, the cycle data set corresponding to the timing signal; and
a timing control unit for outputting the timing signal according to the cycle data set.

11. The interface control circuit of claim 10 wherein the timing control table further comprises a level data set, and the level data set is related to the timing signal.

12. The interface control circuit of claim 10 being installed in a circuit system, the circuit system being coupled to at least a second circuit system via the interface control circuit, wherein content of the timing control table conforms to requirements of the second circuit system.

13. A method for transmitting data, the method comprising:
determining a predetermined sequence according to a data select sequence table; and
arranging and transmitting the data according to the predetermined sequence.

14. The method of claim 13 further comprising:
determining at least a pin according to a pin select sequence table; and
sequentially transmitting the data via the pin.

15. The method of claim 13 further comprising:
sequentially transmitting the data via the pin according to a cycle data set.

16. A method for transmitting data, the method comprising:
determining at least a pin according to a pin select sequence table; and
sequentially transmitting the data via the pin.

17. The method of claim 16 further comprising:
sequentially transmitting the data via the pin according to a cycle data set.

18. A method for outputting a control signal comprising:
determining an output/input timing according to an output/input timing control table; and
outputting the control signal according to the output/input timing.
